(19) United States
(12) Patent Application Publication
(10) Pub. No.: US 2017/0249912 A1
(43) Pub. Date: Aug. 31, 2017

(54) METHOD AND APPARATUS FOR CONTROLLING INFORMATION DISPLAY AREAS IN A MIRROR DISPLAY

(71) Applicant: 3M INNOVATIVE PROPERTIES COMPANY, ST. PAUL, MN (US)

(72) Inventors: George D. Kokkosoulis, Cedar Park, TX (US); Jane K. Wardhana, Jakarta (ID)

(21) Appl. No.: 15/597,191

(22) Filed: May 17, 2017

Related U.S. Application Data
(63) Continuation of application No. 13/625,190, filed on Sep. 24, 2012, now abandoned.

(51) Int. Cl. G09G 3/36; G06F 3/0481

(52) U.S. Cl. CPC G09G 3/3611; G09G 2340/0407; G06F 2203/04803; G06F 3/0481; G09G 2354/00

(57) ABSTRACT

A mirror display with controllable information display areas. The mirror display includes a reflective viewer side to function as a mirror and an LCD device located on a non-viewer side to provide information display areas, which are viewable through the mirror display on the viewer side. A processor is electronically connected with the LCD device for controlling a position, such as the location and size, of the information display areas on the viewer side of the mirror. The position of the information display areas can be controlled via user input or a signal received from a sensor associated with the mirror.

### BACKGROUND

One type of mirror display includes a mirror with a liquid crystal display (LCD) device positioned behind the mirror. The mirror uses a reflective polarizer on glass to provide for a mirror-like highly reflective surface on the viewer side. When the LCD device is on and displaying information, the polarized light from the LCD device can pass through the reflective polarizer and is visible through the mirror. When the LCD device is off or not displaying information, the reflective polarizer in the area over the LCD device is not passing light from it and thus only reflects light to function as a mirror. These mirror displays do not provide for user interaction with the LCD device and only transmit information to the user when the LCD device is on. Accordingly, a need exists for a mirror display with increased functionality to provide for user interaction with it and other ways to change the displayed information.

### SUMMARY

A mirror display with controllable information display areas, consistent with the present invention, includes a mirror having a reflective viewer side and a non-viewer side opposite the viewer side. An LCD device is located on the non-viewer side of the mirror and is capable of displaying information display areas, which are viewable through the mirror on the viewer side. A processor is electronically connected with the LCD device for controlling a position of the information display areas on the viewer side of the mirror.

A method for controlling information display areas on a mirror display, consistent with the present invention, includes displaying information display areas on a mirror having a reflective viewer side and a non-viewer side opposite the viewer side. The information display areas are provided from the non-viewer side of the mirror and are viewable on the viewer side. The method also includes using a processor to control a position of the information display areas on the viewer side of the mirror.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of a system for controlling information display areas in a mirror display;

FIG. 2A is a front view of a mirror display having a substantially full information display area;

FIG. 2B is a front view of a mirror display having a partial information display area;

FIG. 2C is a front view of a mirror display having two partial information display areas;

FIG. 3A is a front view of a mirror display illustrating moving an information display area;

FIG. 3B is a front view of a mirror display illustrating expanding or contracting an information display area;

FIG. 3C is a front view of a mirror display illustrating dividing an information display area into multiple information display areas; and

FIG. 4 is a flow chart of a method for controlling information display areas in a mirror display.

### DETAILED DESCRIPTION

Embodiments of the present invention include a mirror display that allows a user to arbitrarily position and re-size discrete information display areas within the mirror. Other embodiments include controlling the information display areas in the mirror display based upon particular events.

FIG. 1 is a block diagram of a system for controlling information display areas in a mirror display 10. Mirror display 10 includes a reflective polarizer 14 attached to a glass sheet 18 on a non-viewer side using an optically clear adhesive (OCA) 16 to create a mirror. The viewer side of mirror display 10 is on the side of the glass sheet opposite reflective polarizer 14. An LCD device 12 is located behind reflective polarizer 14 on the non-viewer side of mirror display 10. Reflective polarizer 14 is oriented such that it will pass polarized light output from LCD device 12 when the LCD device in on and displaying information display areas. In the other areas of LCD device 12 not displaying information, reflective polarizer 14 only reflects light from the viewer side and functions as a mirror. As an alternative to use of a reflective polarizer, glass sheet 18 can have a black surface on the non-viewer side in the areas around LCD device 12, and LCD device 12 can have the desktop background set to black to provide for a mirror on the viewer side. Use of a reflective polarizer is preferred for increased brightness compared with use of a half mirror.

An information display area is a discrete area displaying information on the LCD device. The information display areas are viewable on the viewer side of the mirror by the LCD device transmitting light through the reflective polarizer and glass sheet. Information display areas are typically rectangular but can have other shapes. Preferably, the areas of the LCD device not displaying information display areas are set to a black background so that those areas are not transmitting light through the reflective polarizer and glass sheet. An information display area can comprise the entire display area of the LCD device. The information display areas can be repositioned or resized using, for example, the Windows desktop and one of the Windows operating systems by Microsoft Corporation, in which case the information display areas are typically referred to as windows.

A sensor 20 is associated with mirror display 10. A host computer 24 is electronically connected with sensor 20 for receiving signals from the sensor. Host computer 24 is also electronically connected with LCD device 12 for use in controlling information display areas on mirror display 10 based upon signals received from sensor 20. Alternatively, host computer 24 can control the information display areas programmatically based upon particular events. For the electronic connection, host computer 24 can have a wired or wireless connection, or both, with sensor 20 and LCD device 12.

Sensor 20 can be located proximate mirror display 10 for receiving commands from a user to control a position of the information display areas. For example, sensor 20 can be implemented with an active depth sensor to receive gesture commands for use in controlling a position of information display areas on mirror display 10. Examples of an active depth sensor include the KINECT sensor from Microsoft Corporation and the sensor described in U.S. Patent Application Publication No. 2010/0199228, which is incorporated herein by reference as if fully set forth.

Sensor 20 can also be implemented with other types of sensors associated with mirror display 10 and not necessarily located proximate the mirror display. For example, sensor 20 can be implemented with a motion sensor or switch. Sensor 20 can be implemented with multiple sensors, for example a sensor located proximate mirror display 10 and another sensor not located proximate mirror display 10.

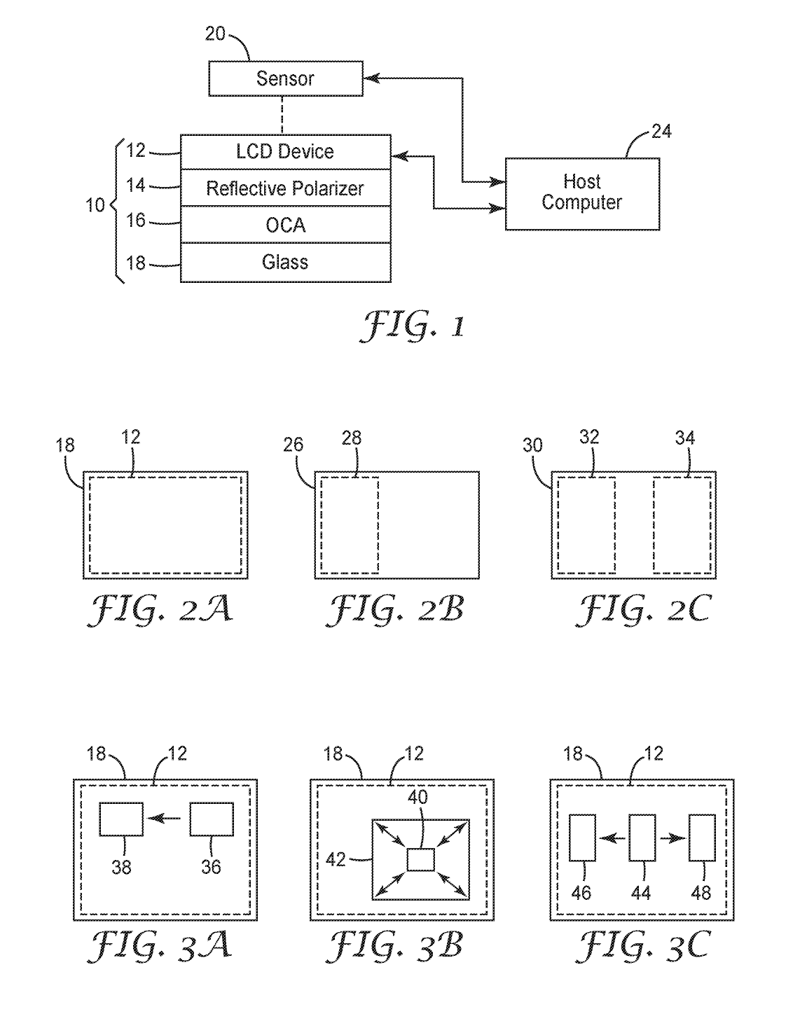

FIGS. 2A-2C are front views illustrating various embodiments of a mirror display. FIG. 2A is a front view of mirror display 10 having a substantially full information display area from LCD device 12 where glass sheet 18 is substantially the same size as a display area of LCD device 12, meaning the area where LCD device 12 can display information display areas. FIG. 2B is a front view of a mirror display having a partial information display area where glass sheet 26 is substantially larger than LCD device 28, for example the information display areas are less than half the area of the mirror display. FIG. 2C is a front view of a mirror display having two partial information display areas where glass sheet 30 has multiple LCD devices 32 and 34 to create multiple distinct areas on the mirror display for the information display areas. The embodiments shown in FIGS. 2B and 2C can have the same construction as shown in FIG. 1 except that the one or more LCD devices are substantially smaller than the glass sheet.

FIGS. 3A-3C illustrate examples of ways to control information display areas viewable on mirror display 10. FIG. 3A is a front view of mirror display 10 illustrating moving an information display area from a first location 36 and a second location 38. FIG. 3B is a front view of mirror display 10 illustrating expanding or contracting an information display area between locations 40 and 42. FIG. 3C is a front view of mirror display 10 illustrating dividing an information display 44 area into multiple information display areas 46 and 48. The information display areas can be repositioned or resized based upon user input, which includes gestures as detected by a depth sensor or input entered using a cursor control device such as a mouse or trackball. The information display areas can also be repositioned or resized based upon other types of input.

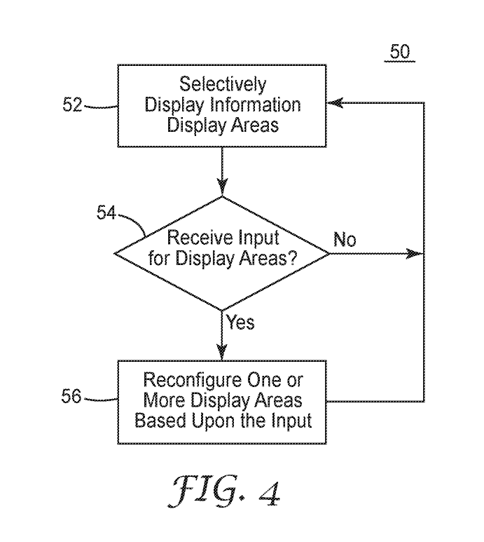

FIG. 4 is a flow chart of a method 50 for controlling information display areas in a mirror display. Method 50 can be implemented in, for example, software executed by a processor such as host computer 24 for controlling information display areas on mirror display 10. In method 50, host computer 24 selectively displays information display areas on mirror display 10 (step 52). If host computer 24 receives input relating to the information display areas (step 54), host computer 24 reconfigures one or more of the information display areas according to the input (step 56) and displays the one or more reconfigured information display areas (step 52). The input can be received from sensors, cursor control devices, or events determined programmatically.

Aside from controlling a position of the information display areas based upon user commands, they can be controlled in other ways. For example, a motion sensor can detect when a person approaches the mirror display and, in response, move the information display areas to one or more sides of the mirror display such that the center is usable by the person as a mirror.

A mirror display can optionally accommodate more than one viewer. For example, this type of mirror display can utilize not just a proximity sensor but also or instead a more precise location sensor. When multiple users approach the mirror display, the active information display areas are repositioned away from the area directly in front of them and in such a way that those areas do not interfere with either adjacent information display areas or the areas that are used as a mirror.

The following are additional examples of events that can be used for controlling information display areas in a mirror display. Based upon a particular time of day, the mirror display can activate or move a position of the information display areas. A mirror display installed above a water sink in a bathroom can display weather, news, or stock information within information display areas during the times, for example morning hours, when someone is getting ready for work, and a user can enter the specific times during which such information will be displayed. A mirror display in a store fitting room can have current advertisement and store special sales provided in information display areas that automatically move to the sides when someone stands in close proximity in front of the mirror display.

1. A mirror display with a controllable information display area, comprising:
a mirror having a reflective viewer side and a non-viewer side opposite the viewer side, wherein the mirror comprises a glass sheet and a reflective polarizer on the non-viewer side of the glass sheet;
an LCD device located on the non-viewer side of the mirror and having a display area capable of displaying information and having at least one information display area displaying information within the display area, wherein the information within the information display area is viewable through the mirror on the viewer side;
a processor electronically connected with the LCD device for controlling a position of the information display area;
a first sensor, located proximate the LCD device, electronically connected with the processor for providing a first signal to the processor for use in controlling the position of the information display area; and
a second sensor, not located proximate the LCD device, electronically connected with the processor for providing a second signal to the processor for use in controlling the position of the information display area,
wherein the processor controls the position of the information display area on the viewer side of the mirror based upon both the first and second signals, and the position of the information display area is reconfigurable between a first position within the display area and a second position within the display area different from the first position.

2. The mirror display of claim 1, wherein areas of the display area not displaying the information display area are set to a black background.

3. The mirror display of claim 1, wherein the mirror further comprises an optically clear adhesive between the glass sheet and the reflective polarizer.

4. The mirror display of claim 1, wherein the first or second sensor comprises a depth sensor.

5. The mirror display of claim 1, wherein the first or second sensor comprises a motion sensor.

6. The mirror display of claim 1, wherein the position of the information display area includes a location of the information display area on the viewer side of the mirror.

7. The mirror display of claim 1, wherein the position of the information display area includes a size of the information display area on the viewer side of the mirror.

8. The mirror display of claim 1, wherein the LCD device includes a plurality of LCD devices located on the non-viewer side of the mirror.

9. The mirror display of claim 1, wherein the display area of the LCD device is substantially a same size as the mirror.

10. A method for controlling an information display area on a mirror display, comprising:
displaying at least one information display area on a mirror having a reflective viewer side and a non-viewer side opposite the viewer side, wherein information displayed within the information display area is provided from the non-viewer side of the mirror and is viewable on the viewer side of the mirror, wherein the mirror comprises a glass sheet and a reflective polarizer on the non-viewer side of the glass sheet; and
controlling, using a processor, a position of the information display area on the viewer side of the mirror based upon a first signal from a first sensor located proximate the mirror and upon a second signal from a second sensor not located proximate the mirror,
wherein the position of the information display area is reconfigurable between a first position within the mirror and a second position within the mirror different from the first position.

11. The method of claim 10, wherein areas of the mirror capable of but not displaying the information display area are set to a black background.

12. The method of claim 10, wherein the controlling step comprises controlling the position of the information display area based upon the first or second signal received from a depth sensor.

13. The method of claim 10, wherein the controlling step comprises controlling the position of the information display area based upon the first or second received from a motion sensor.

14. The method of claim 10, wherein the controlling step comprises controlling a location of the information display area on the viewer side of the mirror.

15. The method of claim 10, wherein the controlling step comprises controlling a size of the information display area on the viewer side of the mirror.

16. The method of claim 10, wherein the displaying step comprises using a plurality of LCD devices to display the information display area on the viewer side of the mirror.

17. The method of claim 10, wherein the displaying step comprises displaying the information display area on substantially all areas on the viewer side of the mirror.
